(19) United States
(12) Patent Application Publication
(10) Pub. No.: US 2007/0008304 A1
(43) Pub. Date: Jan. 11, 2007

(54) Digital pen and method of use

(76) Inventor: Jennefer Margaret Tobin, Dumfries (GB)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/566,564

(22) PCT Filed: Jul. 28, 2004
(86) PCT No.: PCT/GB04/03281

§ 371 Date: Sep. 13, 2006

(30) Foreign Application Priority Data
Jul. 31, 2003 (GB) 03178761

(51) Int. Cl. G09G 5/00

(52) U.S. Cl. 345/179

(57) ABSTRACT

A digital pen (1) contains an identity tag reader (3, 4) for identifying places, individuals or items to each of which a written data record relates. Each place or individual is marked with an identity tag (20, 36) whose identity and location are recorded in a database. The digital pen reads the tag and stores and uploads its identity in association with the penstroke data record, providing a verifiable indication that the data record was created at the tag location. The data record may require to be written within a defined time period after reading the tag. The database may be used to produce forms (22, 30) on digital paper for use with the pen in creating hospital, maintenance and inspection and other records.

This invention relates to digital pens and to methods of using digital pens to record data.

Digital pens are writing instruments which capture penstroke information as it is created and then upload it to a computer for processing and storage, perhaps after preliminary processing within the pen. A digital pen conveniently resembles a conventional pen and is manipulated by the user in a similar way to write or draw on a surface. As the user writes or draws, sensors in the pen capture a digital record of the pen strokes which are created. These pen stroke data—which is to say, the data representing the corresponding visible marks which a corresponding conventional pen would have made if manipulated in the same way—are then uploaded by the pen, for example via a Bluetooth (TM) wireless link or a cradle, and perhaps via the internet, to a processing computer which recognises and processes the penstroke data and stores and displays the information as images, implements it as instructions or converts it into another format.

A digital pen may include a conventional nib which assists the user by leaving a visible trace on the written surface; alternatively the pen may leave no visible trace. The sensors may detect the visible trace left by the pen, the motion, position, pressure, or orientation of the pen, and/or any other variables or parameters relating to the interaction between the pen and the written surface so as to record the penstroke information.

When the pen is used for writing text, an Optical Character Recognition or equivalent programme may be used to convert the penstroke data into a standard computer readable text format so that the user's handwriting can be stored, processed and displayed on screen by a conventional word processing application. Where the pen is used to draw diagrams or pictures these may be stored as images or converted into other formats.

By writing with a digital pen on so-called “digital paper”, which is available for example from Anoto AB of Lund, Sweden, information encoded on the paper can be used to determine the way in which the penstroke data are processed. A digital paper comprises a spatially varying pattern which extends over a very large number of pages and can be printed page by page onto writing paper so that it is virtually invisible to the naked eye but can be detected by optical or other sensors in the digital pen.

Each part of the pattern of a digital paper is individually recognisable and is stored on a computer in association with instructions which determine how the penstroke information which is written over that part of the pattern is to be processed. This enables for example a form to be printed which contains a number of boxes, each requiring a defined entry such as a tick, a number, a drawing, or a body of handwritten text, and each containing a defined portion of the pattern. The information written in each box with the digital pen is captured by the digital pen together with that part of the pattern over which it is written, and is processed (within the pen and/or after being uploaded to a remote computer) according to the instructions associated with that portion of the pattern.

When it is written upon a digital paper, a penstroke may thus be processed (depending on the instructions associated with it, for example by virtue of that part of the pattern over which it is written, or of that part of the pattern over which an associated penstroke is written) as representing an instruction or other stored data rather than a digital representation of the corresponding visible mark which a conventional pen would have created. For example, the penstroke data may be processed in accordance with rules which specify that text enclosed by a continuous handwritten line is to be erased, or is to be processed as instructions relating to text not so enclosed; and so forth. In this specification the term “penstroke data” is accordingly to be construed as including any data recorded (including instructions to be implemented) either directly or indirectly as the result of a penstroke.

Certain portions of the pattern may also be recognised as instructions by the pen itself, so as to prompt the pen for example to upload some or all of the penstroke or pattern data or other information to a remote computer when a penstroke is applied to that portion of the pattern. Alternatively the pen may upload the data in response to some other signal, such as a user operated control or an internal memory overflow monitor. The pen may also receive instructions in return from the remote computer, which may for example prompt it to process the penstroke data and then upload them to a further remote computer for further processing and storage.

Digital pens and digital paper will find applications in many situations where data are collected in a systematic and verifiable way. Examples of such applications include maintenance surveys, safety reports and operational logs in ships, railway networks, factories and the like; ward rounds and nursing records in hospitals; and numerous other situations where data must be collected and recorded by an individual carrying out an inspection or examination. In all of these applications it is important to record reliably and accurately the place or individual to which the data record relates.

For example, in the shipping industry, the hull of a cargo vessel must be regularly surveyed for corrosion and fatigue; the enclosed volumes of the holds may need to be monitored for the buildup of toxic or explosive gases; and the condition of numerous items of safety-related equipment must be systematically monitored and all of the resulting information recorded. Similarly, in the railway industry it is vital to examine, perhaps thousands of miles of tracks and points regularly and systematically for signs of wear and incipient failure and to record evidence of this inspection and maintenance. Regular monitoring and sampling is also necessary in air conditioning and water supply systems to detect the presence of biological contaminants.

Verifiable and consistent record keeping in relation to such inspection regimes is equally important, particularly where the failure to identify and respond to a hazard could expose the operator of the system or equipment to the risk of causing damage to people or to the environment and to statutory liability.

It is particularly important to know that the data relating to repeated inspections at a particular location came from the same location on each occasion.

Often however an inspection regime will involve onerous and dirty work in manually inspecting perhaps distant or uncomfortable locations. Inspection work is often entrusted to a number of different maintenance personnel, perhaps employed by subcontractors and speaking a variety of languages, making it difficult to track the personnel and to rely on their performance, and the individual employee may be tempted to make do with a cursory inspection, thus failing to spot the vital signs of failure. Worse still, he may decide to collect data or samples from a more convenient location instead, and make out a false report.

Simple confusion may also lead to data being wrongly indexed. Where a large number of locations are to be inspected, it is still more difficult to ensure that the data are correctly recorded. It is known for example to record data from a large number of test points in accordance with a “walking list” which describes each test point in turn. Where the operator is unfamiliar with the installation, the instructions may be confused and the data collected or recorded in the wrong order. It is important therefore for the operator of the system or equipment to ensure that the inspection regime is reliable and the data or samples are collected consistently from the same and correct locations.

In hospitals and similar environments it is equally important to ensure that an examination or test record relating to one patient is not confused with the identity of another patient.

The use of digital pens, either alone or with digital paper, enables individuals carrying out such inspections, examinations or the like to upload the recorded data quickly and conveniently to one or more computer based databases where the record can be stored in a standardised and accessible form. This helps to ensure that records are maintained correctly and systematically and reduces the likelihood that recorded data will be lost or misfiled or that errors will be introduced during transcription into its final format when compared with conventional written records.

However, whilst the use of digital pens and, optionally, digital paper improves the process of creating and storing records, the problem of potential error remains. It is the aim of the present invention to provide a means by which data may be more reliably collected by means of a digital pen.

According to a first aspect of the present invention there is provided a digital pen, comprising a writing instrument for use by a user to create penstrokes and including means for recording the penstrokes as penstroke data and means for uploading the penstroke data to a computer;

characterised in that the pen is used in association with a plurality of identity tags, each tag being fixed at a location at which penstroke data are to be recorded, and the identity of each tag being stored in association with its location; and in that there is provided identity tag reading means associated with the pen for reading the identity of each identity tag, together with means for associating the identity read from each said identity tag with the penstroke data recorded at its associated location.

According to a second aspect of the invention there is provided a method of recording penstroke data by means of a digital pen, wherein a plurality of identity tags are affixed, each to a location at which penstroke data are to be recorded, and the location of each identity tag is recorded in association with its tag identity in a database; the method comprising the steps of

(a) reading the tag identity of a first said identity tag by means of an identity tag reader associated with the digital pen;

(b) using the digital pen to record penstroke data relating to the location of the first identity tag; and

(c) processing and storing the penstroke data in association with the first tag identity.

It is important when completing inspection reports or the like that each record is linked to the location to which it relates. This can be done by means of a digital pen by writing the name, location or other identifying details relating to a data record at the top of the record with the digital pen, or by providing a box on a form printed on digital paper which is associated with processing instructions which ensure that the record is indexed according to the identity details entered in that box. This however does not prevent incorrect information from being entered in the box—for example, by filling in patient names after completing the ward round from an out-of-date list of hospital bed occupancy, by confusing patients' names, or by deliberately entering incorrect location information in order to speed up a workshift requiring the inspection of equipment at a remote or inconvenient location.

The method and apparatus according to the invention facilitate the implementation of a regime of data collection using a digital pen, wherein each data record can be reliably and verifiably linked to the location at which it was created by means of the association between the identity of the tag at that location, which may be securely recorded in a database and physically verified by external inspection or the like, and the penstroke data record. The present invention may be applied to a wide variety of situations where data are to be recorded relating to individuals (such as patients in a hospital), geographical locations (such as sections of a railway track), items of fixed or mobile equipment, localities in a ship, and so forth, and in this specification the term “location” is therefore to be construed to include any person, item, place or other thing or point at or on which an identity tag may be fixed, which is to say, located.

Further features and advantages will become apparent from the various illustrative embodiments and scenarios of use of the invention which will now be described by way of example and with reference to the accompanying drawings, in which:

FIG. 1 shows a digital pen according to a first embodiment of the invention;

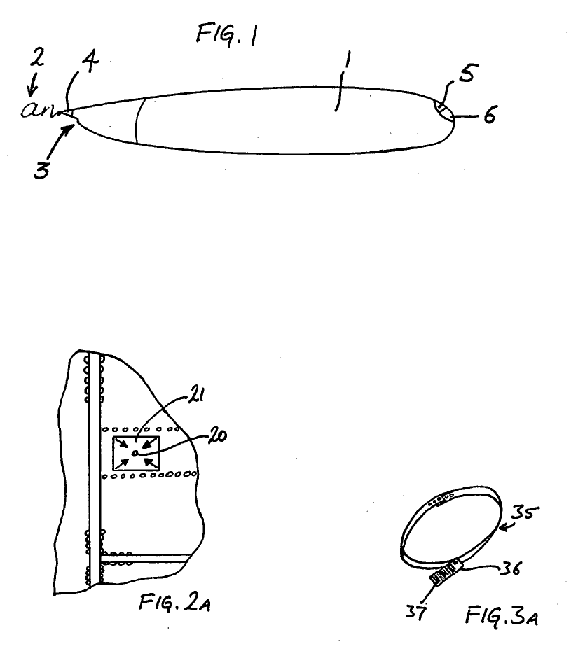

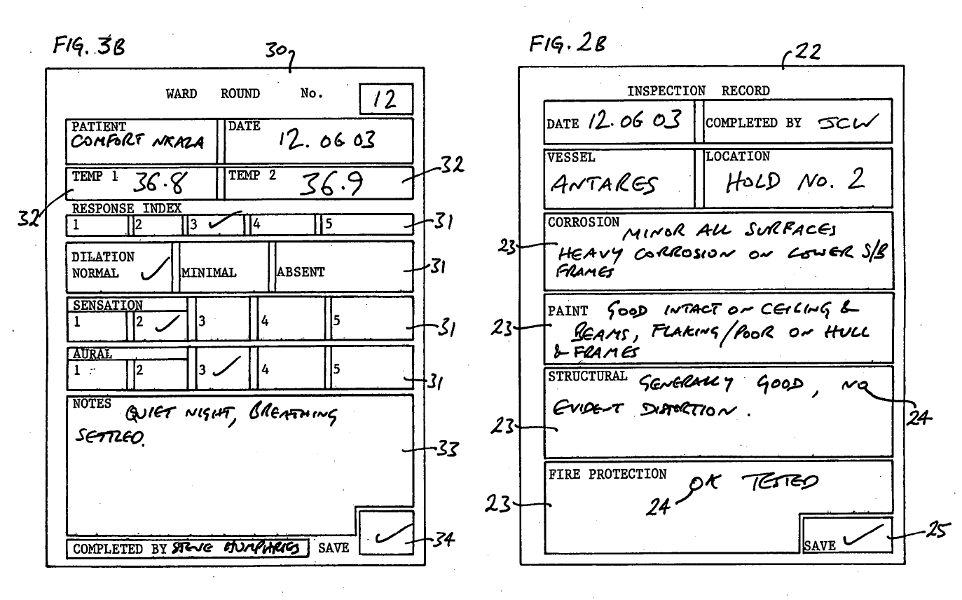

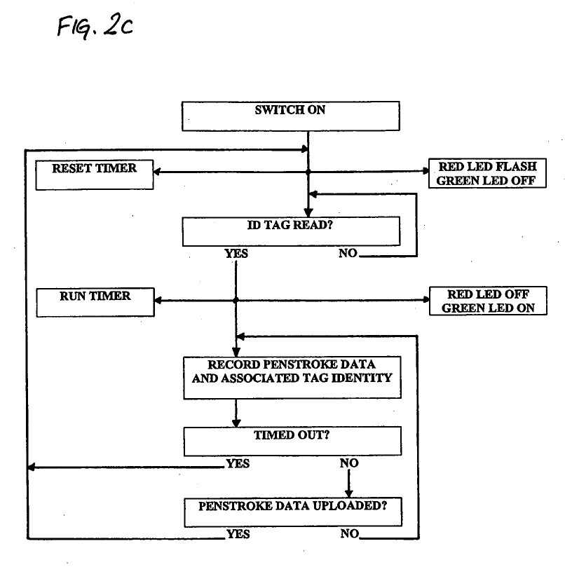

FIG. 2A shows a contact identity tag affixed to part of the interior of a ship's hold in a first illustrative scenario;

FIG. 2B shows an inspection report form relating to the ship's hold shown in FIG. 2A after completion with the digital pen of FIG. 1;

FIG. 2C shows a simplified flowchart relating to the first scenario of FIGS. 1, 2A and 2B;

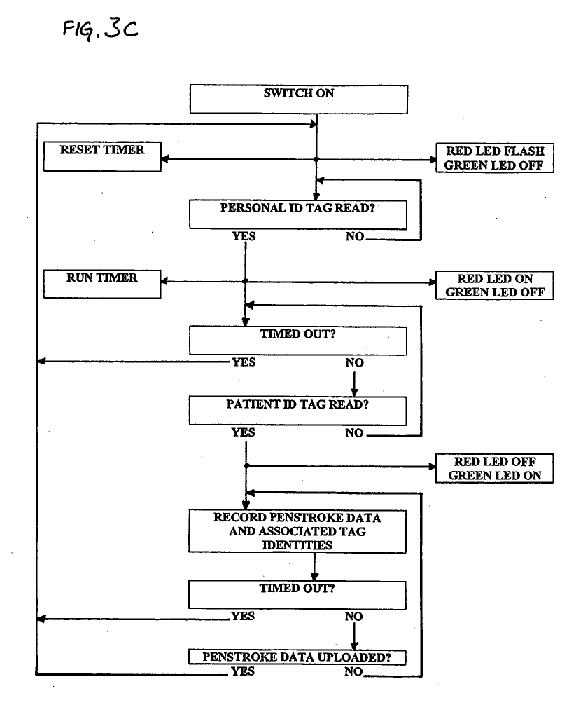

FIG. 3A shows a bracelet with a barcode for use by a hospital patient in a second illustrative scenario;

FIG. 3B shows a hospital report form after completion with the digital pen of FIG. 1; and

FIG. 3C shows a simplified flowchart relating to the second scenario of FIGS. 1, 3A and 3B.

Referring to FIG. 1, a digital pen comprises a body 1 containing sensors and a memory for recording penstrokes 2 made by a user as penstroke data, together with a power source, internal processing means, and means for uploading the recorded and partially processed penstroke data to a remote computer (not shown) for further processing and storage.

The sensors may comprise optical sensors arranged in a window 3 at the tip of the pen, pressure or motion sensors which sense the orientation, position or motion of the pen and/or the pressure placed on the nib 4 against the writing surface, and/or any other type of sensor enabling the pen to capture the penstroke data. Conveniently the nib 4 is capable of making a visible trace 2 on the writing surface; depending on the sensing means employed however the pen may be arranged to leave no visible trace.

The uploading means may comprise a wireless connection, using for example the short range Bluetooth (TM) standard, a cradle or docking station (not shown) into which the pen may be inserted when the user has finished working with it, a hard wire link or any other convenient means. Conveniently the penstroke data may be uploaded to the processing computer, either directly or over the internet, via a mobile telephone or other communicating device worn by the user. Alternatively a dedicated local network of receivers may be provided for relaying data from the pen. The pen may also carry a removable and interchangeable memory cartridge for storing the penstroke data for uploading later to the processing computer.

In alternative embodiments the user may be provided with a data storage or capture device in operable association with the pen which may be carried or worn by the user to store data from the pen for uploading later to the processing computer, and some or all of the logical functions of the pen may then be performed by the data storage device, or even (where the pen is in continuous communication) by the processing computer. The data capture device may also perform the function of the processing computer. The processing computer may comprise a single, central computer located at a secure processing facility, a distributed network of computers, or any other convenient arrangement.

The nib 4 of the pen is integral with a pair of small, sharp contact identity tag probes forming part of a contact identity tag reader located within the body 1 of the pen. In use, the probes are pressed against a contact identity tag in order to read its identity. The identity of the tag is then stored by the pen in association with the recorded penstroke data as further explained below.

In alternative embodiments of the invention the probes may be provided elsewhere on the body 1 of the pen, or the contact identity tag reading means may be provided separately from the pen, for example on a probe or wand, and associated with it by means of a hard wire or short range wireless link, a data transfer cradle or the like.

A red light emitting diode (LED) 5 and a green LED 6 are inset into the pen body 1 and serve to indicate to the user whether or not the specified conditions associated with the tag identity have been satisfied, as further explained below.

Referring to FIG. 2a, in a first illustrative scenario according to the first embodiment of the invention a plurality of contact identity tags 20 are provided, each tag being affixed to a specified location in a ship at which inspection data are to be recorded. A high visibility label 21 is provided to help inspection personnel to locate the tag within the ship's structure.

The location of each tag 20 is recorded in association with its unique tag identity in a database. The database may be located on one or more central computers or servers, and may be password protected or otherwise secured and verified by independent authorities.

Referring to FIG. 2B, the central database may be organised in accordance with a maintenance or inspection schedule. A subset of tag identities is then downloaded from the central database as each inspection round falls due, and may be used for example to print a set of inspection report forms 22 with a description and instructions relating to each respective location which is due to be visited.

In the example shown a standardised form 22 is printed on digital paper, bearing a pattern which is virtually invisible to the eye but is readable by optical sensors in the window 3 of the pen. The form 22 is used for carrying out a standard periodical inspection regime in the holds of each ship in a fleet, and defines a number of individual checks 23 which are to be carried out. The user writes a report relating to each item in the relevant box 23 provided on the form, and as he does so the optical sensors in the window 3 of the pen capture both the penstrokes 24 as penstroke data and the part of the pattern of the digital paper which is contained within that box 23.

When the penstroke data and the associated pattern segment are uploaded to the processing computer the penstroke data are processed in accordance with the instructions stored in the processing computer against that part of the pattern. Thus for example the text which the user has written into the first box 23 marked “corrosion” may be first converted by the processing computer into a standard computer readable text format, and then stored as a text entry in a database of corrosion data relating to each ship in the fleet, as well as in a master database containing records of all inspections carried out. Similarly the content of the other boxes 23 may be stored in a database relating to those other defined aspects of maintenance across the fleet.

Special instructions or conditions may be stored and downloaded in association with each tag identity, and may for example program the digital pen or its associated data capture device to accept data only where the conditions are fulfilled. For example, the conditions may specify a maximum time period which may elapse between reading the tag and recording the penstroke data. This allows the individual using the digital pen enough time to read a tag and then record the penstroke data whilst ensuring that the data record is created at the tag location.

Different conditions or different values of specified conditions may be associated with each tag; thus for example a tag on an overhead beam or another inaccessible location may allow the user a five minute time period within which to record the data record, allowing the user to move to a comfortable location after completing the inspection before he writes up the record. A tag in an easily accessible location where other tags are located close by may only allow a period of one minute for recording the penstroke data record, in order to ensure that the identities of different tags are not confused.

Alternatively the conditions associated with each tag 20 may specify that a data record will only be created when another tag is read together with it. For example, tag 20 might be located at a fire extinguisher mounting point, and a further tag located on a foam type fire extinguisher. In order to ensure that the correct type of extinguisher is fitted at that location, both tag identities must be read together (for example, within a period of fifteen seconds) in order for the associated penstroke data record to be created. Other conditions may specify values of associated input data, the identity of the individual carrying out the inspection (preventing for example tags in hazardous locations from being tested by unauthorised personnel), or any other desired combination of circumstances.

The specified conditions may be stored permanently in the pen, or may be downloaded from a central database to the memory of the digital pen, or to a memory cartridge located in the pen, at the beginning of the inspection round, or alternatively downloaded to a data capture device associated with the pen and worn by the user; the logical functions necessary to implement the specified conditions may be located in the pen or in the data capture device, or even (where the pen is in constant communication) in the processing computer. Alternatively the specified conditions may be implemented by the processing computer at the processing stage, so that penstroke data may be captured by the pen together with data relating to the specified conditions, but will not be accepted for later processing or storage in association with the tag identity unless the specified conditions were fulfilled at the time that the data were captured by the pen.

Referring now to FIGS. 1, 2A, 2B and 2C, the first scenario illustrates one implementation of the method of the invention, wherein the specified conditions associated with the tag 20 specify that a maximum time period of four minutes may elapse between reading the identity of the tag 20 and completing the penstroke data record, which is to say, uploading the inspection report of FIG. 2B by placing a mark with the digital pen of FIG. 1 in the “save” box 25. This ensures that the individual creating the data record has visited the location of the tag 20 and written his report on site, rather than waiting until later and writing it up from memory, when details of the inspection may be forgotten or even falsified. It also ensures that the record relates to the location of the tag 20 and not to the location of another tag.

At the beginning of the inspection the individual collects a set of forms 22, which may be printed with detailed instructions downloaded from the central database showing the location of each inspection point and its associated tag, and optionally downloads specified conditions relating to one or more of the tags to the pen or associated data capture device. He then proceeds to the first inspection point and switches on the pen. This resets a timer in the pen to zero, and prompts the red LED 5 to flash, indicating that the pen requires a tag identity to be read before penstroke data will be recorded. The green LED 6 remains off.

He then touches the contact identity tag 20 with the tag reader probe 4. The tag reader reads the tag identity and stores it in a memory in the pen or in the data capture device. This prompts the timer to run and turns the red LED 5 off and the green LED 6 on, indicating that the user may commence writing his report 22. The user fills in the boxes indicated on the form 22. When he has finished he places a penstroke in the “save” box 25.

The “save” box 25 contains a pattern segment which is recognised by the pen 1 (or by the software in the associated data capture device worn by the user) as an instruction to upload the penstroke data written on the remainder of the form. This finishes the process of penstroke data recording and resets the timer and LEDs to their initial state.

If the user takes more than four minutes to complete the form, the timer and LEDs automatically reset to their initial state, and the penstroke data are no longer recorded. The flashing red LED indicates to the user that he must re-enter the tag identity to continue recording; he touches the probe 4 against the tag 20 once more, and continues filling in the form. When he has finished, he places a penstroke in the box 25 and the recorded penstroke data are uploaded to the processing computer or to the data capture device for processing later.

In refinements, a visible or audible warning from a piezoelectric sounder or the like may be given so that the user can re-read the tag before the timer runs out.

In an alternative embodiment, the recording must be initiated within the specified period, after which the penstroke data may continue to be recorded until the user places a penstroke in the “save” box 25 on the digital form 22, prompting the pen to upload the data and resetting the timer and LEDs to their initial state. A new tag identity must then be read in order to restart the procedure and create a fresh data record on a fresh form 22.

In an alternative embodiment, instead of interrupting the process of data recording when the timer times out, penstroke data may continue to be recorded after the specified period, but the time delay after reading the tag identity may be recorded in association with the data. This ensures that data are always recorded, but allows irregularities in the data recording and tag reading process to be monitored and compared between one individual and another.

The use of contact memory type identity tags rather than remotely interrogated tags offers the advantage that the personnel carrying out the inspection are compelled to reach the location of the tag in order to collect the data, precluding any possibility of false recording or inadequate inspection. Thus for example where it is essential to inspect the floor plating of a ship's locker, a contact identity tag may be fixed to the floor of the locker, compelling the user of the device to remove the contents of the locker in order to gain access to the tag. Reading of the tag thus equates to certification that the precise location in question has been visited.

Various types of active and passive identity tag are known, including optically readable barcode tags and electronically readable memory tags. Electronically readable tags typically comprise a microchip or other data carrying device which is encoded with an identity, such as a binary number which is unique to that tag, together with means for reading the tag identity remotely, for example by means of radio frequency interrogation, or by contact. Electronic identity tags may carry other information in addition to the tag identity, and may also be writable and erasable. Passive tags benefit in comparison with active tags from enhanced reliability and longevity since no power supply is required, and are hence preferred.

A particularly preferred form of tag comprises a small passive button type contact identity tag containing a microchip or the like which is encoded with the tag identity. The button is robust, impervious to moisture and capable of withstanding long exposure to harsh environments, and in use may be attached to a surface by any convenient means, such as gluing its base, capturing a flange behind a riveted collar or the like. The use of contact rather than remotely interrogated tags also reduces power consumption and allows the tag reader to be more compact, enhancing portability, as well as avoiding the potential for inadvertent reading of the wrong tag.

The contact tag 20 is readable by contacting an inner terminal simultaneously with the tag casing, which forms an outer terminal, by means of the pointed contacts of the probe 4 so as to form an electrical circuit. The pointed contacts enable the probe in use to penetrate any accumulated dirt or paint film so as to contact the tag, whilst the durable construction of the button type tag 20 allows any gross contamination to be scraped from the surface of the tag without damaging it.

It will be appreciated that other types of tag and tag reader may be selected for use in accordance with the invention. For example, a barcode reader might be used instead of or in addition to the contact tag reader; however, barcoded tags placed in outdoor or marine environments are vulnerable to being painted over or washed or scraped off.

In a development, a remote tag reader may be used in addition to or in place of the contact tag reader. Preferably the reader has a very short range, so that it must almost touch the tag before the tag can be read. Alternatively it may be capable of reading an RFID or other passive electronic identity tag over a short, defined range—for example, ten centimetres, two metres or ten metres—by radio frequency interrogation or equivalent means. This enables the tag to be read even where for example it is obstructed by debris; however, the added convenience for the individual using the device entails added uncertainty for the operator of the plant or equipment, since the user may read the tag without closely inspecting the location to which it is affixed.

Alternatively longer range RFID or other tags may be employed, for example for inventory control of goods within a warehouse or of vehicles within a compound.

In certain situations, such as where the tag is to be affixed on an overhead beam and inspection from floor level only is desired, a remote tag reader and remotely readable tags may therefore be preferred; preferably the tags are readable only over a short, defined range. In most inspection applications however, contact type identity tags are preferred since this ensures that the individual carrying out the inspection has gained access to the precise location where the inspection is to be made.

In a further refinement, a contact type tag may include a remotely sensed element, and either the tag reader or the tag itself may incorporate a sounder or flashing light which indicates when the tag is in range. This assists the individual carrying out the inspection in locating the tag.

Verification of an inspection regime implemented in accordance with the invention may be accomplished by the verifying authority or inspector periodically visiting each identity tag and recording its tag identity and location, then cross checking these against the database. The integrity of the database and apparatus according to the invention may be verified by means of password protected software, mechanical seals on the body 1 of the pen or its associated wand or data capture device, and equivalent means. The apparatus and method of the invention thus enable the operator of the inspection regime to show compliance with his statutory obligations to inspect and maintain whilst ensuring that his maintenance and inspection personnel are carrying out their duties conscientiously.

Preferably the date and time at which the penstroke data were recorded or uploaded are also automatically recorded in association with the penstroke data and the tag identity.

The identity of the user of the digital pen may be stored, either within or in association with the digital pen, allowing each data record created by the pen to be associated with the individual to whom the pen was issued. This further improves the traceability and verifiability of data records so created. The name and signature boxes on the form may then be cross checked against the electronic identity record of the pen user. A number of digital pens may be used in association with a single central database, and the identity of each pen may similarly be recorded.

Alternatively or additionally, the identity of the individual carrying out the inspection is recorded by reading a personal identification tag assigned to that individual and also storing this tag identity in association with the penstroke data. This enables the progress of the inspection to be monitored, whilst by cross checking the time taken by different personnel to carry out the inspection of a given set of locations, irregularities in the inspection may be identified. This further enhances the integrity of the collected data and provides proof of presence of each inspection worker, which may also be correlated with his access privileges, such as, for example, authorisation to open and inspect railway signalling junction boxes.

In the embodiment described, the user is provided with printed paper forms which can be retained as a reference copy for cross checking against the electronic record. Alternatively the form 22 may be printed on digital paper and then laminated so that the trace left by the pen may be wiped off after each inspection and the same form is then re-used for the next standard inspection. Alternatively the nib 4 of the pen may be arranged to leave no visible trace on the form.

In further alternative embodiments the form 22 may be printed on ordinary paper and the penstroke data record merely processed according to instructions stored in the computer to which it is uploaded; the instructions may be specific to the tag identity. The penstroke data record may thus be created on an ordinary sheet of paper, or even on any convenient surface, and no visible written record may be required. This may be convenient where only a single text report is required, rather than a number of entries against a number of specified categories of information. Digital paper is preferred however, especially where a complex form is used, because it enables each item of information to be processed according to its position on the form; thus a tick in a tick box, or a figure entered into a box, will be automatically interpreted correctly when it is processed in accordance with the pattern in the box.

Referring to FIGS. 1, 3A, 3B and 3C, a further embodiment of the invention is illustrated by reference to a second scenario where the digital pen is used to create a record of a ward round in a hospital. The digital pen is as described with reference to the first scenario, except that in place of the contact identity tag probe 4 and contact identity tag reader, a barcode reader is incorporated into the pen body 1 for reading barcode identity tags through the window 3.

A standard report form 30 is printed on digital paper from data held on a central database at the hospital's computer centre, and includes tick boxes 31, boxes 32 for entering the patient's temperature as numerical data and a box 33 for writing a brief description of the patient's condition. The penstroke data entry in each box are processed according to the instructions stored in the processing computer in the hospital's computer centre in association with the pattern printed in that box when the contents of the form 30 are uploaded to it by ticking the “save” box 34.

Each patient on the ward is issued with an identifying armband 35 with an identity tag 36 bearing a barcode 37, and the identity of the barcode is stored on the processing computer against the patient's record. The doctor carrying out the round is also issued with a personal identification tag whose identity is also stored on the processing computer in association with the doctor's details.

At the beginning of the ward round the doctor collects a set of report forms and switches on his digital pen, prompting a timer inside the pen to reset to zero and the red LED to flash. This indicates that the doctor is required to read his personal identification tag. In the embodiment shown, the doctor's identification tag is read before completing each report; alternatively however the doctor may be required to log on only once when switching on his pen at the beginning of the round.

When the pen reads the personal identification tag the timer begins to run and the red LED 5 turns on continuously, indicating that the pen is ready to read the first patient's identity tag. If no patient identity tag is read before the timer runs out, then the pen resets to its initial condition. If a patient identity tag barcode 37 is read, then the red LED turns off and the green LED turns on, indicating that the doctor may commence writing the data record, which is stored by the pen in its internal memory in association with the doctor's personal identification tag identity and the patient's identity tag identity. When the timer runs out, the pen stops recording and the timer and LEDs reset to their initial condition; the doctor may then check box 34 to upload the stored data, or re-read both tags in order to continue filling in the form before uploading the penstroke data to the processing computer.

It will be appreciated that the present invention may be applied to a wide variety of situations where it is desired to collect data by means of a digital pen, either with or without the use of digital paper, and the invention may thus be practised in other ways than those illustrated above within the scope of the claims. For example, the pen need not include LEDs or other indicators, or even a timing mechanism or any other logical system for implementing specified conditions associated with the tag identities. The pen may also take other physical forms from that illustrated, and the data capture and transmission functions may be performed in any convenient way. The steps of the method may also be carried out in a different order from that shown. It is also possible that the location information relating to each identity tag may be encoded on and read from the tag itself rather than stored on a computer based database, so that the tags themselves then constitute the database of tag identity and location information.

In summary, embodiments of the invention provide a digital pen which contains an identity tag reader for identifying places, individuals or items to each of which a written data record relates. Each place or individual is marked with an identity tag whose identity and location are recorded in a database. The digital pen reads the tag and stores and uploads its identity in association with the penstroke data record, providing a verifiable indication that the data record was created at the tag location. The data record may require to be written within a defined time period after reading the tag. The database may be used to produce forms on digital paper for use with the pen in creating hospital, maintenance and inspection and other records.

1. A digital pen (1), comprising a writing instrument for use by a user to create penstrokes (2)
and including means for recording the penstrokes as penstroke data
and means for uploading the penstroke data to a computer;
characterised in that the pen is used in association with a plurality of identity tags (20, 36),
each tag being fixed at a location at which penstroke data are to be recorded,
and the identity of each tag being stored in association with its location;
and in that there is provided identity tag reading means (3, 4) associated with the pen for reading the identity of each identity tag,
together with means for associating the identity read from each said identity tag with the penstroke data recorded at its associated location.

2. A digital pen according to claim 1, characterised in that the identity tag reading means (3, 4) is integral with the pen.

3. A digital pen according to claim 1, characterised in that means are provided for associating at least a first tag identity with specified conditions,
such that penstroke data are associated with the first tag identity only where the penstroke data are recorded and the first tag identity is read by the identity tag reading means in accordance with the specified conditions.

4. A digital pen according to claim 3, characterised in that there is provided at least one personal identification tag, the identity of the personal identification tag being stored in association with the identity of the user,
and the conditions specify that at least one personal identification tag must be read by the identity tag reading means in association with the recorded penstroke data.

5. A digital pen according to claim 3, characterised in that indicating means (5, 6) are provided for indicating to the user whether or not the specified conditions have been satisfied.

6. A digital pen according to claim 3 or claim 4, characterised in that the conditions specify a maximum time period which may elapse between reading the first tag and/or the personal identification tag and recording the associated penstroke data.

7. A digital pen according to any of claims 1-5, characterised in that means are provided for recording in association with the penstroke data the time and date at which the data were recorded or uploaded.

8. A digital pen according to any of claims 1-5, characterised in that the identity tag reading means (4) comprises contact identity tag reading means for reading the identity of an identity tag (20) by physically contacting the tag.

9. A digital pen according to any of claims 1-5, characterised in that the identity tag reading means (3) comprises a barcode reader.

10. A method of recording penstroke data by means of a digital pen (1), wherein a plurality of identity tags (20, 36) are affixed, each to a location at which penstroke data are to be recorded, and the location of each identity tag is recorded in association with its tag identity in a database;
the method comprising the steps of
(a) reading the tag identity of a first said identity tag by means of an identity tag reader (3, 4) associated with the digital pen;
(b) using the digital pen to record penstroke data relating to the location of the first identity tag; and
(c) processing and storing the penstroke data in association with the first tag identity.

11. A method according to claim 10, characterised by the additional step of
(d1) after step (a), measuring a predetermined elapsed time period,
wherein step (c) is completed only where step (b) is initiated within the predetermined elapsed time period.

12. A method according to claim 10, characterised by the additional step of
(d2) after step (a), measuring a predetermined elapsed time period,
wherein at step (c) only penstroke data recorded at step (b) within the predetermined elapsed time period are processed and stored in association with the first tag identity.

13. A method according to any of claims 10, 11 or 12, characterised by the additional steps of
(e) providing a personal identification tag to the user of the pen;
(f) recording the identity of the personal identification tag in association with the identity of the user in a database;
(g) reading the identity of the personal identification tag with the identity tag reader, and
(h) at step (c), processing and storing the penstroke data in association with the identity of the personal identification tag.
